(19) United States
(12) Patent Application Publication
(10) Pub. No.: US 2005/0236474 A1
(43) Pub. Date: Oct. 27, 2005

(54) System and method for controlling access and use of patient medical data records

(75) Inventors: Lambert P. Onuma, Honolulu, HI (US); Alan S. Ito, Honolulu, HI (US); Bradley J. Mossman, Honolulu, HI (US); Robert R. Albertson, Pleasanton, CA (US); Shirley S.S. Pai Hilton, Honolulu, HI (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Convergence CT, Inc., Honolulu, HI (US)

(21) Appl. No.: 11/092,997

(22) Filed: Mar. 28, 2005

Related U.S. Application Data
(60) Provisional application No. 60/556,589, filed on Mar. 26, 2004.

(51) Int. Cl. G06K 5/00

(52) U.S. Cl. 235/382

(57) ABSTRACT

A system for processing patient health information (PHI) protects the confidentiality of PHI to achieve regulatory compliance. The PHI contains patient medical data and associated patient identification data. A de-identification agent extracts patient medical data and separates from all identification data to create de-identified patient data. A key is generated that allows subsequent reassociation of the patient medical data and the patient identification data. The de-identified patient data base may be queried for patient screening purposes. Patient queries are processed only if the study or patient screening has been authorized by appropriate authorities, such as an internal review board. Patients whose medical characteristics conform with the patient query are selected for possible use in a study. If re-identification of the selected patients is necessary, and authorized, the key may be used to provide the necessary reassociation. A data log records all access to patient data.

### BACKGROUND OF THE INVENTION

1. Field of the Invention

The present invention is directed generally to computer record keeping and, more specifically, to a system and method for controlling access to and use of patient medical data records.

2. Description of the Related Art

The use of computers to store records, such as patient medical data records, is well known. Conventional security measures, such as user passwords, are typically used to prevent unauthorized access to the patient medical records. If a user has the appropriate password, medical data records, including confidential protected health information, is accessible to the user. Proper health care delivery to the patient may dictate such access. However, there are other situations in which it is desirable to limit access to patient information or to prohibit access altogether.

In one example, the Health Insurance Portability and Accountability Act of 1966, known as HIPAA, mandates security for protected health information by organizations, such as hospitals. Large research institutions, such as universities and research facilities, may typically employ one or more staff members to ensure HIPAA compliance. However, many institutions do not have large budgets to permit the use of dedicated personnel to ensure HIPAA compliance.

In other circumstances, it is desirable to limit access to patient data records independent of any regulatory requirement. Accordingly, there is a significant need for a system and method that will control access to protected health information in hospital operations and in research environments. The present invention provides this and other advantages as will be apparent from the following detailed description and accompanying figures.

### BRIEF SUMMARY OF THE INVENTION

In an exemplary embodiment, a system constructed in accordance with the present teaching controls access to a protected health information (PHI) storage structure that stores patient identification data and associated patient medical data. The system comprises a de-identified data structure that stores patient medical data in a manner that is disassociated from the patient identification data. A key file contains data interrelating the disassociated patient identification data and the patient medical data. An authorization controller processes data access requests. When the authorization controller receives an access request, the received access request is compared with a predetermined data access authorization and, if the received access request complies with the predetermined data access authorization, permitting access to the patient medical data.

The system further comprises a de-identification agent to process the patient identification data and associated patient medical data to thereby disassociate the patient medical data and the patient identification data to thereby generate the disassociated patient medical data. The de-identification agent generates a key related to the patient identification data and the associated patient medical data to thereby permit subsequent reassociation of the disassociated patient medical data and the patient identification data. The key is stored in the key file and, in one implementation, may be a random key.

The system may further comprise a re-identification agent to process data in the key file and thereby reassociate the patient medical data and the patient identification data to thereby generate re-identified patient medical data if the received access request requires such association. In an exemplary embodiment, the received access request for re-identified patient medical data is processed by the authorization processor and the re-identification agent reassociates the patient medical data and patient identification data only if the predetermined data access authorization permits such reassociation.

The system may further comprise a patient query agent having user-selectable patient selection criteria with the patient query agent being configured to query patient medical data and select patients having characteristics conforming to the user-selectable patient selection criteria. In an exemplary embodiment, the patient query agent is configured to query the disassociated patient medical data in the de-identified data storage structure. In an exemplary embodiment, patient medical data selected from patients having characteristics conforming to the selection criteria are placed in a de-identified query data storage structure.

In one embodiment, the received access request indicates a type of data required and a purpose associated with the use of the required data. The authorization processor accepts authorization input based on a review board authorization to permit access to de-identified patient medical data or patient medical data associated with the patient identification data.

The authorization processor may also control subsequent use of patient medical data to which access is permitted. In one embodiment, the authorization processor permits subsequent use of the medical data only for a predetermined period of time. In an alternative embodiment, the authorization processor prohibits printing of patient medical data to which access is permitted. In another alternative embodiment, the authorization processor prohibits copying of patient medical data to which access is permitted. A log monitors access to patient medical data and can generate reports related thereto.

In an alternative embodiment, the system may be implemented in a multiple medical institution environment in which each medical institution has a PHI storage structure. In this embodiment, the multiple medical institutions may share a de-identified data storage structure. The medical institutions may also share a de-identification agent. Alternatively, a de-identification agent may be delivered to a selected one of the plurality of medical institutions and process patient identification data in associated patient medical data in the PHI storage structure of the selected one of the plurality of medical institutions. In this embodiment, the delivered de-identification agent may deliver patient medical data or may only deliver summary patient medical data to the de-identified data storage structure.

### BRIEF DESCRIPTION OF THE DRAWING(S)

FIG. 1 is a functional block diagram of a computer network implementation in accordance with the teachings of the present disclosure.

FIG. 2 is a flow chart providing an overview of information flow in a system implemented in accordance with the present teachings.

FIG. 3 is a flow chart illustrating the data flow in a single hospital environment.

FIG. 4 illustrates the operation of the system to create a new query.

FIG. 5 illustrates an example of a result set generated as a result of the query of FIG. 4.

FIG. 6 provides additional detail of the resultant set of FIG. 5.

FIG. 7 illustrates an example of an expanded query.

FIG. 8 illustrates the result set of the expanded query of FIG. 7.

FIG. 9 illustrates additional data provided by the results set of the expanded query.

FIG. 10 is a state diagram illustrating the security procedures implemented by the system of the present invention.

FIG. 11 is a work flow product overview.

FIGS. 12A-12B together form a flow chart illustrating the operation of the system for data set generation.

FIGS. 13A-13B together form a flow chart illustrating the operation of the system for patient recruitment data usage.

FIGS. 14A-14B together form a flow chart illustrating the operation of patient research data usage.

FIG. 15 is a flow chart illustrating the patient query process in a multi-hospital environment.

### DETAILED DESCRIPTION OF THE INVENTION

As will be discussed in greater detail herein, a computer system and method of operation described herein may be used to provide multiple levels of security and access to patient data. The use of patient data is important in research for clinical trials, patient screening, epidemiological studies and other research. Although concern for patient privacy has always been an issue, the new Health Insurance Portability and Accountability Act (HIPAA) of 1996 has a significant impact on the use of patient level data for research purposes.

As used herein, the term “protected health information” (PHI) refers to patient information that is considered confidential and must be protected. The level of protection associated with PHI data may vary from one application to another. In one embodiment, the level of data security for PHI is commensurate with HIPAA requirements. In other implementations, the degree of security for PHI may be greater than or less than that dictated by HIPAA requirements.

The use of PHI for hospital operations and health care delivery for the patient may also be subject to various levels of security described herein. The use of PHI in operations, marketing or research requires compliance with HIPAA. As will be described in greater detail below, a system constructed in accordance with the present teachings will allow various degrees of access to data based on the level of authorization granted to the individual requesting the data. The system provides secure access to the data and provides restrictions on the use of the data.

Individual patient data records may be stored in a variety of different known manners using conventional technology. However, the creation of databases using PHI is considered research for purposes of HIPAA compliance. The use of PHI in research now requires varying approvals, depending on the use of the PHI and the identity of the individual(s) requesting use of the data. As will be described in detail below, the compliance processes inherent in the system described herein helps automate the approval process, tracks the varying degrees of approval and data access, and permits access only to the approved individual(s).

In addition to limited access to PHI, all disclosures of PHI must be tracked. A hospital or other entity covered by regulations, such as HIPAA, must be prepared to provide the disclosure information to a patient upon request. The system described herein tracks all access to PHI and can readily generate a log report.

In one example, the present invention is embodied in a system 100, which may be most readily understood in the context of a client-server architecture. However, as will be apparent to those skilled in the art, any convenient computer architecture may be employed to implement the system 100. The system 100 is not limited to a client-server architecture.

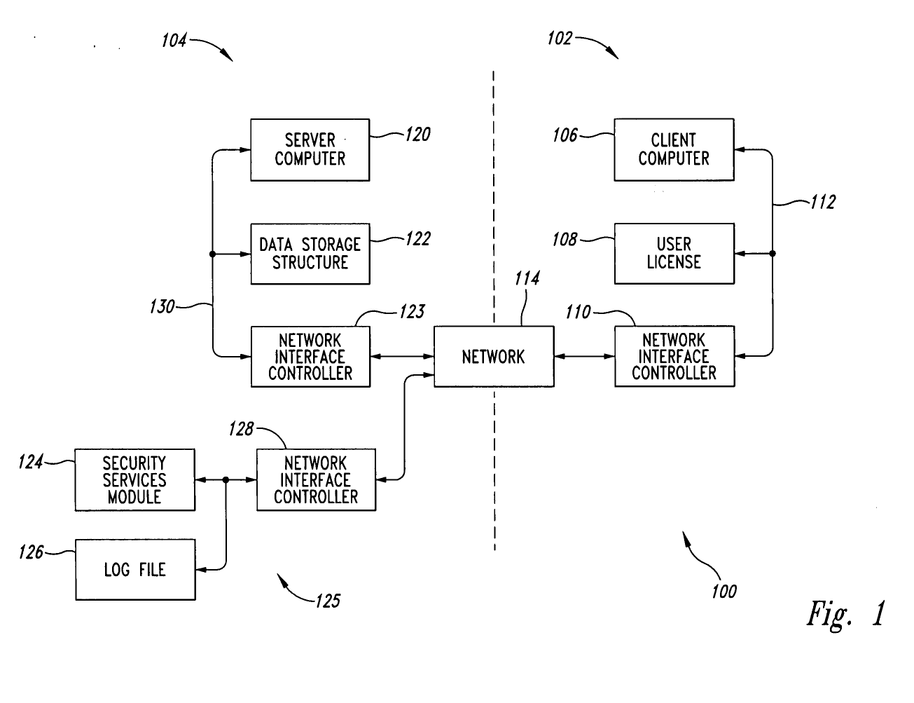

In FIG. 1, the system 100 comprises a client 102 and a server 104. The client 102 includes a client computer 106. For the sake of brevity, the conventional components, such as a disk drive, keyboard, monitor, cursor control device, and the like used to implement the client computer 106 are not shown. Furthermore, the operation of such conventional computer components is well known in the art and need not be described herein.

The client computer 102 also includes a user license 108, which is a document that dictates the conditions and restrictions on the access and use of PHI. The user license 108 may be a hard copy paper delivered to the individual requesting access to data (e.g., a researcher) or may be delivered electronically to the client computer 106. A particular client computer may contain one or more user licenses 108. The license document(s) provide the user with information regarding restrictions on access to data and subsequent use of that data. While the user license 108 may provide documentation of the terms of use of data, the system 100 automatically controls access and use of PHI using a series of secure processes to assure that the use of the PHI is in accordance with any granted license. The secure processes that permit access to patient medical data or records will be described in greater detail below.

The client computer 102 also includes a network interface controller (NIC) 110. The NIC 110 controls communication between the client computer 102 and a network 114. The implementation of the NIC 110 varies depending on the form of the network 114. For example, the network 114 may be a local area network (LAN) or a wide-area network (WAN). The network 114 may provide high speed connectivity (e.g., an Ethernet connection) or may have dial-up modem connections. Accordingly, the NIC 110 uses conventional technology to communicate with the network 114. In one example, the NIC 110 is a high speed network interface that allows high speed connection to the network 114. Alternatively, the NIC 110 may be a conventional telephone modem to permit low speed communication with the network 114.

FIG. 1 illustrates the various components of the client computer 102 coupled together by a bus system 112. The bus system 112 may be an internal bus and/or an external bus, such as an interface cable or a combination thereof. The bus system 112 may comprise a data bus, address bus, power bus, control bus, and the like. For the sake of brevity, the various busses are illustrated in FIG. 1 as the bus system 112.

The server 104 comprises a server computer 120, which is typically part of a computer system in a hospital, research clinic, or other medical institution that may have PHI. As discussed above with respect to the client computer 102, the server computer 120 has a number of conventional components that need not be described herein. Such components may include, by way of example, a memory, disk storage device, monitor, keyboard, cursor controller, and the like. The various conventional components used to implement the server computer 120 are known in the art and need not be described herein. Furthermore, a variety of different combinations of conventional components may be used to implement the server computer 120. The system 100 is not limited by the type or quantity of conventional components used to implement the server computer 120.

The server 104 also includes a data storage structure 122. As will be described in greater detail herein, the data storage structure 122 contains the patient medical data records. In one embodiment, the data storage structure 122 may be implemented as a database in which PHI is stored. Data records processed in accordance with regulatory requirements, such as HIPAA, may also be stored within the data storage structure 122. In an exemplary embodiment, the patient medical data records that have been processed in accordance with HIPAA requirements may be stored in a separate patient database, as will be described in greater detail herein. Although described as one or more databases, the data storage structure 122 may be implemented using a variety of known technologies. The specific form of the data storage structure 122 should not be considered a limitation on the system 100.

The server 104 also includes a network interface controller (NIC) 123. As discussed with request to the NIC 110, the NIC 123 may be implemented in a variety of different manners depending on the particular form of the network 114 and the desired implementation of the server 104. The system 100 is not limited by the specific implementation of the NIC 123.

FIG. 1 shows the various components of the server 104 as coupled together by a bus system 130. The bus system 130 may comprise an internal bus or an external bus, such as an interface cable or a combination thereof. The bus system 130 may comprise an address bus, data bus, power bus, control bus, and the like. For the sake of brevity, those various busses are illustrated in FIG. 1 as the bus system 130.

The system 100 also includes a security services module 124. The security services module may be integrated into the server 104. However, many hospitals or other medical institutions already have existing computer systems. Accordingly, in a typical embodiment, the security services module 124 may be implemented in a separate license server computer 125 that is piggy-backed or added onto the existing computer infrastructure in the medical institution. This eliminates the need for total replacement of existing computer infrastructure and advantageously permits the hospital or other medical institution to control access to PHI. The license server computer 125 may be located at the hospital or may be remotely located. Those skilled in the art will appreciate that distributed networks do not require that computer systems be physically co-located. The system 100 is not limited by a specific computer architecture nor the specific location of the various components of the system.

As will be described in greater detail below, the security services module 124 controls all access to and use of PHI. Those skilled in the art will appreciate that the use of PHI is strictly regulated by HIPAA and may be further regulated by state, local, or institutional rules. It is known that patient medical data that has been disassociated from all patient identification data does not fall within the regulatory requirements of HIPAA. In one implementation, the security services module 124 functions to “de-identify” PHI to thereby disassociate the patient medical data from the associated patient identification data. The security services module 124 does this in a manner that allows subsequent re-identification, if necessary. The advantage of de-identified data is that it is not regulated by HIPAA and may be used without the restrictions imposed by HIPAA regulations. Other governmental or institutional limits on the use of de-identified data may still apply.

Research needs often require patient participation in research or clinical studies. Such participation requires re-identification of the patient and HIPAA compliance for the use of medical information. The security services module 124 generates a key during the disassociation process used in the generation of de-identified data. The key may be subsequently used by the security services module 124 to re-associate the disassociated patient identification data with patient medical data. Other functions and various components of the security services module 124 are described below.

A log file 126 tracks all usage of patient medical data records. As will be described in greater detail below, the log file 126 can be readily used to generate reports of data access and thereby aid in regulatory compliance.

The server 104 also includes a network interface controller (NIC) 128. The NIC 128 allows a convenient tie-in between the security services module 124 and the server computer 104 via the network 114. As discussed with respect to the NIC 110 and the NIC 123, the NIC 128 may be implemented in a variety of different manners depending on the particular form of the network 114. For example, the NIC 128 may be a dial-up modem or a high speed network interface connection, such as an Ethernet connection. Accordingly, the system 100 is not limited by the specific implementation of the NIC 128.

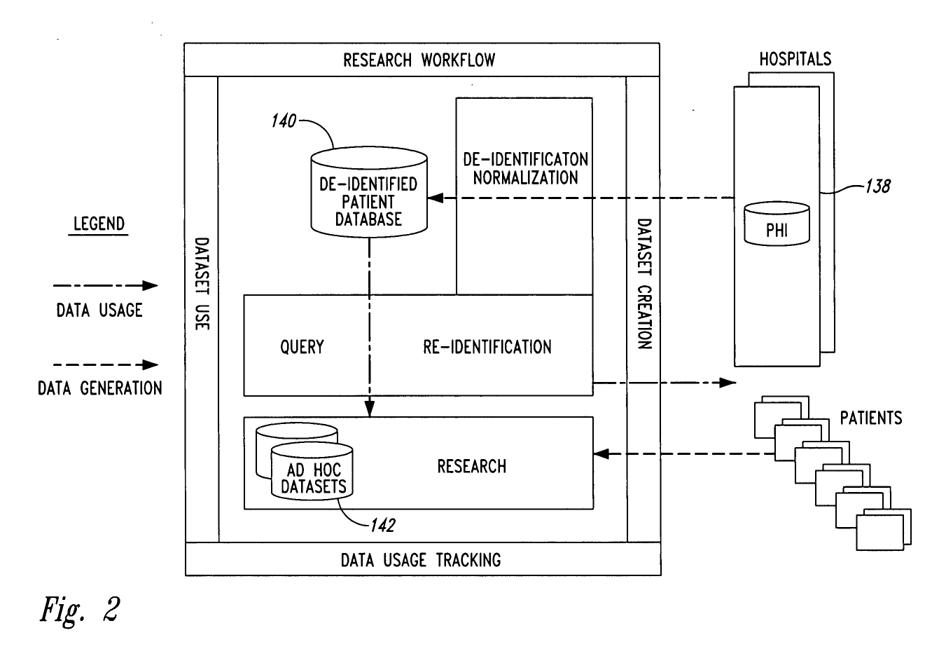

FIG. 2 illustrates an example implementation of the system 100. As shown in FIG. 2, a hospital contains PHI 138, which may be stored in the data storage structure 122 as a database or other convenient storage device. As noted above, PHI 138 contains confidential patient identification data that must be used under the guidelines of HIPAA or other regulatory guidelines. The various regulatory guidelines of HIPAA are known those of skill in the art and need not be described in detail herein. However, it should be understood that the system 100 permits computer control access and use of PHI to meet the regulatory requirements of HIPAA or other state, local or institutional restrictions on the use of PHI. One manner in which PHI may be processed is the de-identification process where all patient identification data is disassociated from patient medical data. HIPAA regulations specify which patient identification data must be removed to create de-identified data. As noted above, de-identified data is not regulated by HIPAA.

As illustrated in FIG. 2, data is extracted from the hospital PHI in a data set creation process and stripped of all identification data. The de-identified patient data is stored in a de-identified patient database 140. The de-identified patient database 140 may also be stored as part of the data storage structure 122 or stored in a separate data storage structure. For example, the de-identified database 140 could be stored in a data storage structure within the license server computer 125 (see FIG. 1).

The de-identified patient database 140 contains information that may be used by researchers to select potential subjects for medical studies or the like. For example, as part of a research workflow a researcher may need a subject population comprising female subjects in a selected age range and having certain predetermined medical characteristics. This type of data is available in the de-identified patient database 140. However, the de-identified patient database 140 contains no data that may be traced back to thereby identify a particular subject.

The de-identified patient database 140 may be queried for patient information, used for patient screening, or the like, as described above. On the basis of queries, unidentified patients may be selected from the de-identified patient database 140 and stored as one or more ad hoc data sets 142. The ad hoc data sets 142 contain patient medical data records that match the selection criteria of the queries. As previously discussed, the PHI 138 is typically part of the hospital computer system. The ad hoc data sets 142 may be stored as another database, and may be part of the data storage structure 122, or part of a separate storage structure. For example, the ad hoc data sets 142 may be part of the license server computer 125 (see FIG. 1).

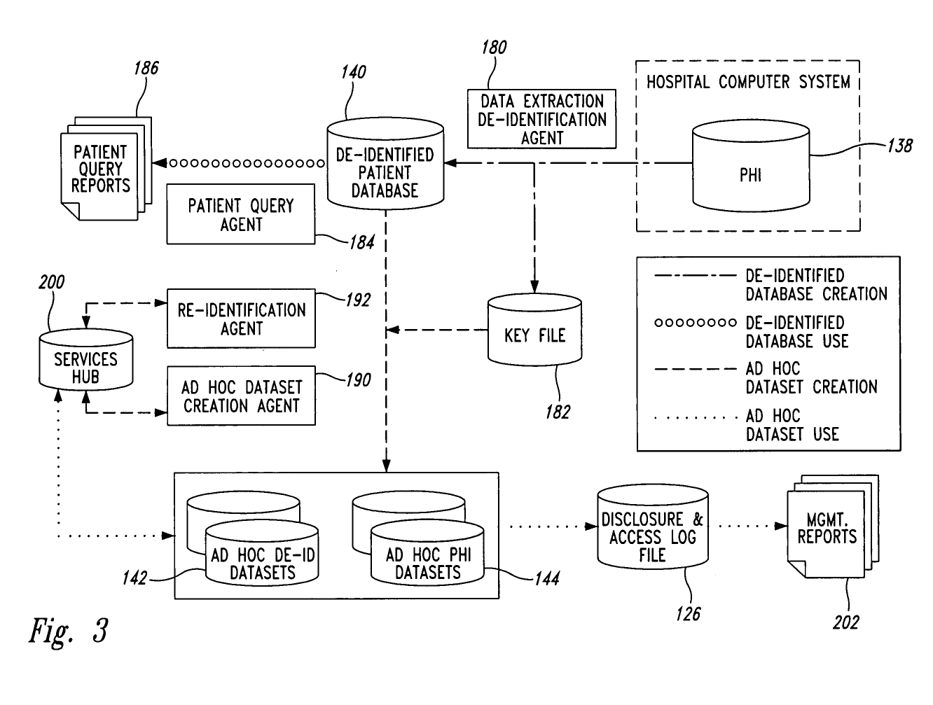

In certain cases, the ad hoc data sets 142 may be used without the need to re-identify a particular patient associated with individual medical data records. In other circumstances, it is necessary to re-identify the patients. Data from the ad hoc data sets 142 that is re-identified may be stored in ad hoc PHI data sets 144 (see FIG. 3). The data in the ad hoc PHI data sets 144 meet the selection criteria, on the basis of previously discussed queries, but has been re-identified to include patient identification data.

Although the de-identified patient database 140 does not contain any identification information, it is possible to re-identify patients using data from the security services module 124 (see FIG. 1). During the de-identification process a random key is assigned to each of the de-identified data records and the key and identification information stored in a key file 182, shown in FIG. 3. The key file 182 may be part of the data storage structure 122 or some other data storage structure. The key file 182 may be stored as part of or in association with the security services module 124 (see FIG. 1).

The key file 182 is used to re-identify the de-identified records that may be needed for a particular research project. As will be described in greater detail below, authorization is checked against information in the security services module 124 prior to any action to assure that the request for information is authorized and that the requested access to data records is in compliance with internal regulations and external regulations (e.g., HIPAA).

All access to patient medial data is recorded in the log file 126 (see FIG. 1). This includes access to the PHI 138, the de-identified data base 140, the ad hoc data sets 142 or the ad hoc PHI data sets 144. Any access to any source of patient medical data is thereby recorded in the log file 126. The log file 126 meets another critical regulatory requirement by tracking access to data and allowing easy generation of reports indicating access to the ad hoc data sets 142. Copying and printing of the PHI is controlled by the security services module 124 (see FIG. 1). Copying and printing of the PHI may also be monitored and stored in the log file 126.

FIG. 3 illustrates the operation of the system 100 in a typical medical institution setting, such as a single hospital environment. With reference to FIG. 3, confidential PHI 138 is stored in a secure storage area. This may be, by way of example, the data storage structure 122 of FIG. 1. Alternatively, the PHI 138 may be stored in another location in the form of a database or other conventional data structure. As illustrated in FIG. 3, the PHI 138 is typically part of the hospital computer system. The hospital may store the PHI in an encrypted form. The system 100 may readily operate with data encryption techniques to prevent unauthorized access of the PHI 138.

The PHI 138 is processed by a data extraction and de-identification agent 180. In a typical embodiment, the data extraction and de-identification agent 180 may be part of the security services module 124. In an exemplary embodiment, the data extraction and de-identification agent 180 may be implemented as a set of computer instructions stored in a memory and executed by the computer associated with the security services module 124 (see FIG. 1). The de-identification process requires the removal or disassociation of any information that may uniquely identify a patient such that the de-identified patient data itself cannot be used to uniquely identify the patient. In accordance with HIPAA procedures, patient name, address, insurance information, dates of service and the like are removed by the data extraction in de-identification agent 180.

The data extraction and de-identification agent 180 generates a random key that will be used in the re-identification process to match de-identified patient data with the associated patient. As a simple example, the data extraction and de-identification agent 180 may generate a random key having a value 123. That random key is stored in the key file 182 in association with the identification data. The random key is also associated with the de-identified patient data to allow subsequent re-identification if necessary. Those skilled in the art will appreciate that the random key in actual operation will comprise a larger number of digits and may include alphanumeric data. A small medical institution with fewer patients may use, by way of example, 16 alphanumeric digits as its key while a larger medical institution may use, by way of example, 32 alphanumeric digits. The specific form of the key may be optimized to provide the desired level of security. The key data is stored in the key file 182. The key file 182 is a secure data storage area that cannot be accessed by researchers or other individuals. If re-identification becomes necessary, secure processes within the system automatically access the key file 182 to reassociate the patient identification data with the de-identified patient medical record data.

The de-identified data is stored in the de-identified patient database 140. As those skilled in the art will appreciate, the de-identified patient database does not fall under HIPAA regulatory requirements because all identification data has been removed. Thus, the de-identified patient database may be used by researchers for patient screening, as discussed above.

It should be noted that all data stored within the license server computer 125 is stored in encrypted form using conventional encryption techniques. In an exemplary embodiment, AES data encryption is used for the de-identified database 140, the ad hoc data sets 142, the ad hoc PHI data sets 144, and the key file 182. Other known forms of data encryption or data security may also be used by the system 100.

A patient query agent 184 is a process used by researchers or other personnel to query the de-identified patient database 140 for medical data records that match patient selection criteria. For example, the patient query agent 184 may query the de-identified patient database 140 to select male HIV-positive patients in a selected age range. The results of the query are provided in the form of patient query reports 186. Those skilled in the art will appreciate that the patient query reports 186 may be delivered electronically or in the form of paper reports. The system 100 is not limited by the specific form of patient query reports 186.

The patient query agent 184 may be readily implemented in the form of computer software instructions executed by the license server computer 125. The form of the patient query agent 184 may be dependent on the form of the de-identified patient database 140. For example, the de-identified patient database 140 may be implemented as a structured query language (SQL) database. In such an implementation, the patient query agent 184 may be in the form of SQL data queries. Those skilled in the art will recognize that other forms of database software may be used to implement the de-identified patient database 140 and the corresponding patient query agent 184.

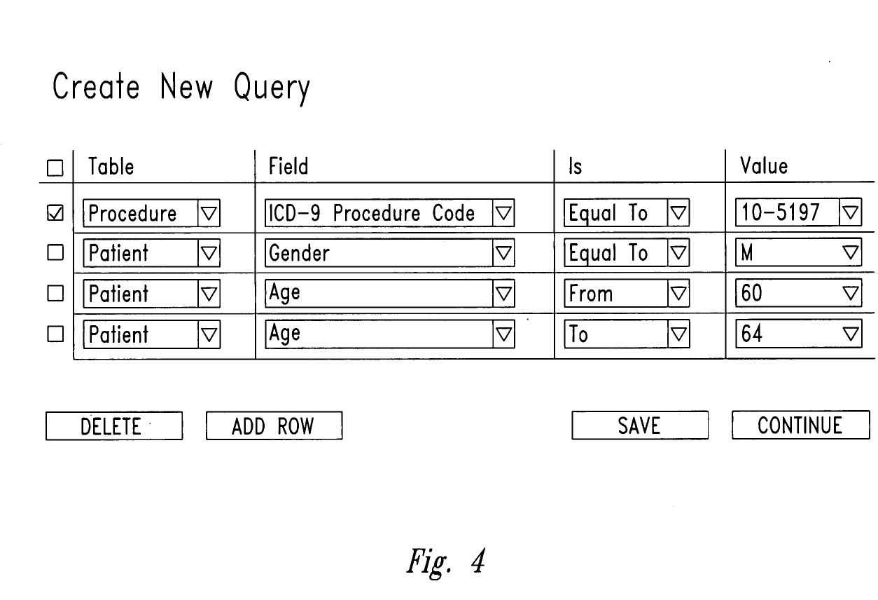

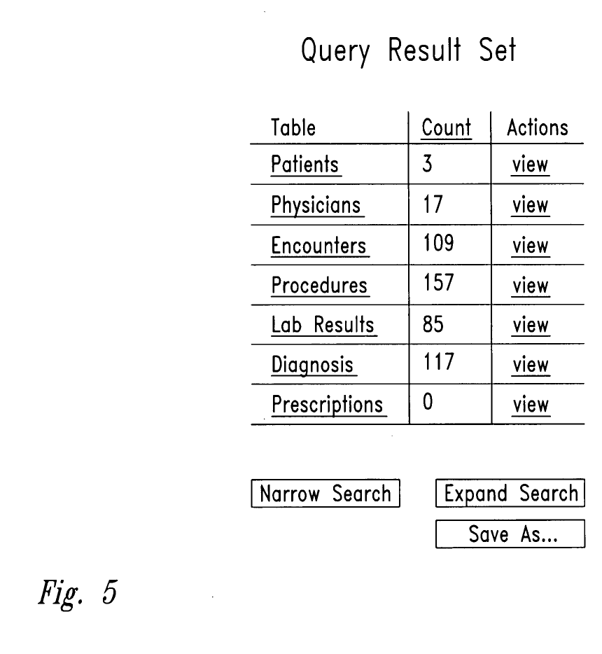

FIGS. 4-9 illustrate the operation of the system 100 in creating and editing queries. In FIG. 4, a new query is created to identify male patients between the ages of 60-64 that have undergone a specific procedure. Those skilled in the art will appreciate that various medical procedures are categorized and may be identified by a numeric value, such as that illustrated in FIG. 4. The patient query agent 184 submits the query to the de-identified patient database 140 (see FIG. 3). The results of the query are presented in the form of the patient query report 186. An example of a patient query report is illustrated in FIG. 5.

As seen in this example, three patients have been identified as matching the selection criteria. The query result set of FIG. 5 also provides information regarding the number of physicians involved with the patients selected as the result of the query and the number of encounters related to the patients selected as part of the query. The number of procedures performed in the encounters related to the patients selected as part of the query and lab results of those procedures are also provided in the query result set. The number of different diagnoses in encounters related to patients selected as part of the query and any prescriptions provided to the patients are also included. One skilled in the art can appreciate that the additional data allows the researcher to screen patients for acceptability in a research study or clinical trial. It is possible to view the query results by clicking on the appropriate action, shown in FIG. 5.

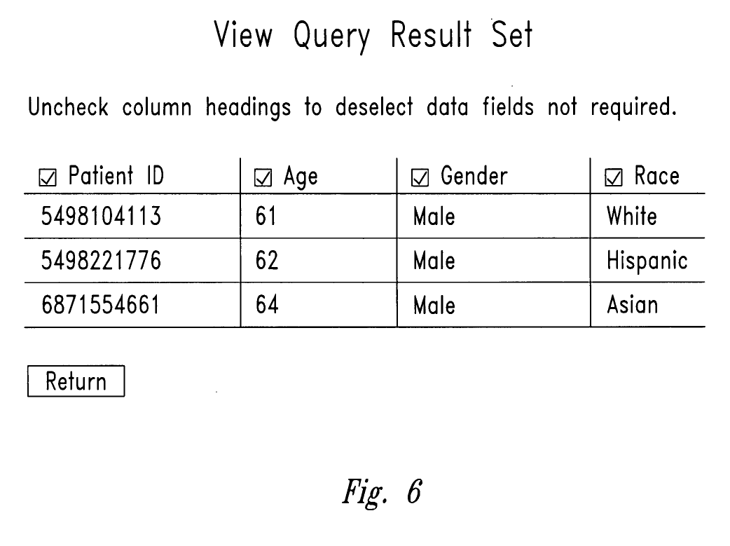

FIG. 6 illustrates a typical display of selected patients screened from the de-identified patient database 140 on the basis of the query. The patient ID is the random patient key discussed previously.

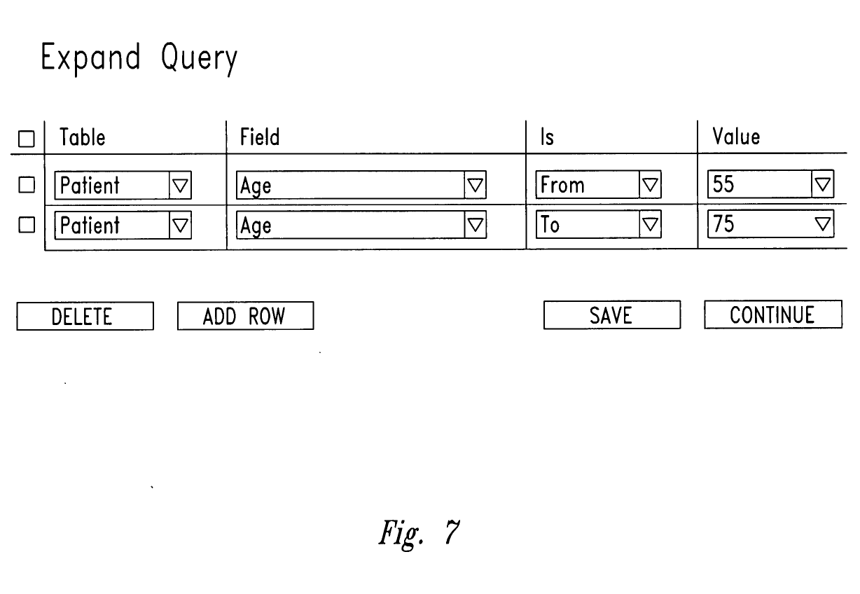

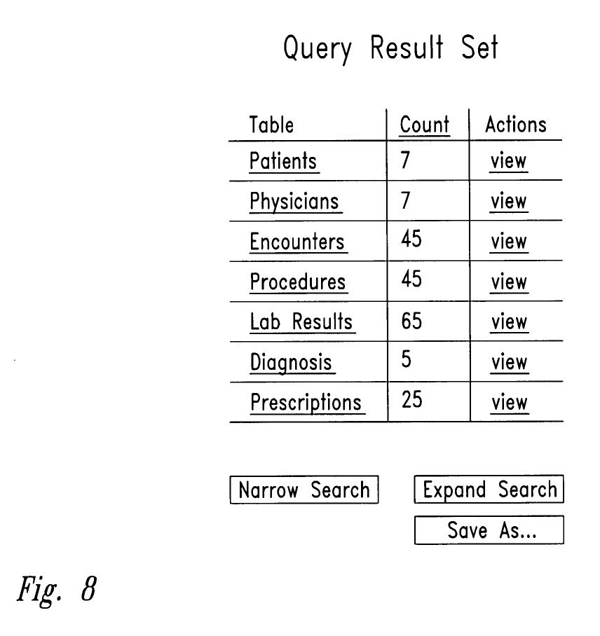

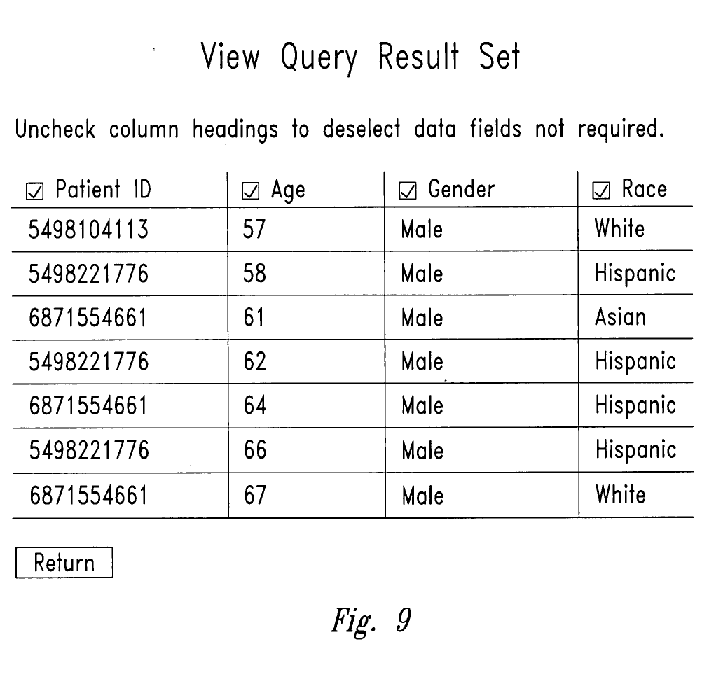

It is possible to expand or narrow the query based on the initial results. FIG. 7 illustrates an example of an expansion of patient query by expanding the patient age range to 55-75 years. The results of the expanded search are provided as a new query result set, illustrated in FIG. 8. The expanded query result set lists the selected patients in FIG. 9. The results of each query may be stored in a conventional manner. In an exemplary embodiment, query search results may be stored in a secure location, such as the data storage structure 122 (see FIG. 1 on the server 104).

On the basis of these queries, patient medical data records are extracted from the de-identified patient database 140 and may be used for clinical or research purposes. An ad hoc data set creation agent 190 constructs the ad hoc de-identified data sets 142 using the results of patient query reports. That is, the researcher selects a number of patients on the basis of one or more patient queries in order to establish a satisfactory set of subjects. The ad hoc data set creation agent assembles the patient medical data records using the patient query selection criteria to generate an ad hoc de-identified data set 142. The system 100 can accommodate multiple researchers and can create multiple ad hoc de-identified data sets 142 corresponding to the needs of each individual research effort.

In some research efforts, specific patient identification data is not required. In this implementation, the researcher may use the de-identified ad hoc data sets 142 to perform the necessary research.

In research that requires the identification of the patient, a re-identification agent 192 accesses the key file 182 to re-identify the patients selected and stored in the ad hoc de-identified data set 142. In the example of FIG. 9, seven patients were selected from the de-identified patient database 140 on the basis of patient queries. In a re-identification process, the patient ID, which corresponds to the randomly selected key, is used to access the key file 182 and thereby reassociate patient identification data with the de-identified patient data records in the ad hoc de-identified data sets 142. This process results in the creation of the ad hoc PHI data set 144. Based on the type of authorization granted to the researcher, the ad hoc de-identified data sets 142 and/or the ad hoc PHI data sets 144 are available for use.

Once the ad hoc data sets 142-144 are created, any access to the ad hoc data set (either the ad hoc de-identified patient data set 142 or the ad hoc PHI data set 144) is recorded in the log file 126 and may be made available in the form of management reports 202.

A services hub 200 controls access to the ad hoc de-identified data sets 142 and the ad hoc PHI data sets 144, as well as the ad hoc data set creation agent 190, and the re-identification agent 192. As will be described in greater detail below, prior to any action by the system 100, the services hub 200 functions as a license server to approve the requested action. For example, access to either the ad hoc de-identified data sets 142 or the ad hoc PHI data sets 144 requires proper authorization. Thus, the services hub 200 performs as an authorization processor whenever access to patient medical data is requested. No patient medical data is provided in the absence of proper approval and authorization.

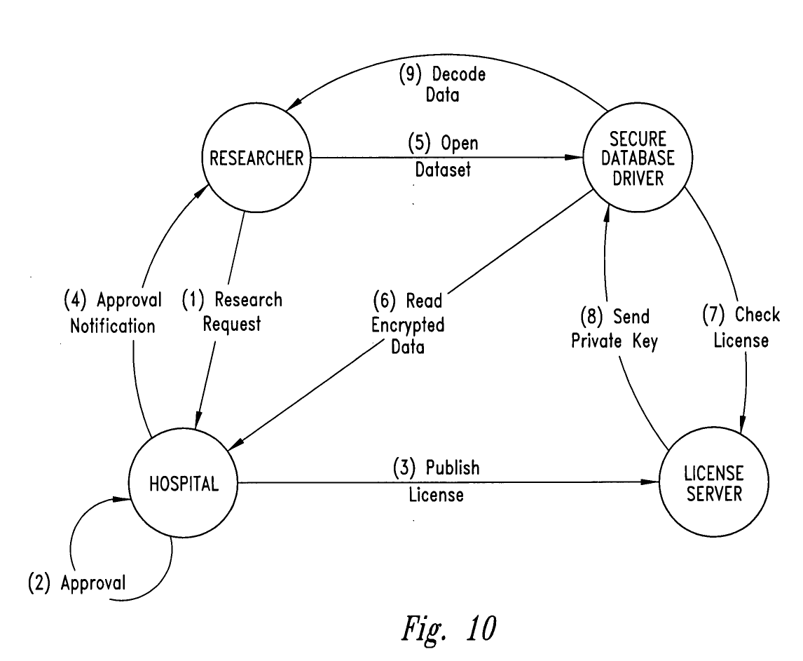

FIG. 10 illustrates the operation of the system 100 to provide the necessary security of patient medical data records (i.e., PHI). The process involves interaction between a researcher and a medical institution (e.g., a hospital). The interaction generally is in the form of electronic communication between the researcher's computer and the medical institution's computer.

At step 1, the researcher provides a research request to the hospital or other research institution. Such requests generally include detailed information regarding the nature of the data required, the purpose of the data requirement, governmental support (e.g., a research grant), and the like. For example, the support documentation may include a description of the study, the specific protocol to be followed and inclusion and/or exclusion criteria for individuals who will be eligible to participate in the study. This information permits the medical institution to evaluate the need for access to the PHI 138.

The hospital must subsequently approve the research request. In a typical embodiment, the approval process is manually performed by an institutional review board (IRB). Although the approval process is manual, the system can automatically generate accompanying documentation for use by the IRB. For example, copies of research proposals or grants may accompany the research request. The system 100 may automatically store copies of the supporting documentation to simplify the review process. Upon authorization by the IRB, a security officer or other authorized individual generates a license which spells out the terms and conditions under which the researcher may have access to the patient medical data records. In step 3, a license is published and stored in a license server. In a typical embodiment, the license server is incorporated in the services hub 200 (see FIG. 3), which in turn may be part of the security services module 124 of FIG. 1 as implemented as implemented on the license server computer 125. A document that outlines the terms of the license may be sent to the researcher in paper form or sent electronically to the client computer 106 as the user license 108 (see FIG. 1). However, the user license 108 does not control access to the patient medical data records. The license server (e.g., the security services module 124 of FIG. 1) controls all access to patient medical data records.

Once the security officer has published the license and stored the license in the license server, approval notification is also provided to the researcher in step 4. The approval notification may also spell out terms and conditions for use of the medical data. Following receipt of the approval notification, the researcher uses a password to access a user account and thereby access the medical records in accordance with the terms and conditions of the license agreement.

In step 5, the researcher opens a data set and the system 100 establishes a secure database driver. As will be described in greater detail below, the secure database driver performs the functions of receiving and decrypting patient medical data. The secure database driver also restricts the type of processing that may be performed on the decrypted patient medical data so that use of the data conforms to the terms of the license.

In step 6, the secure database driver reads encrypted data from the de-identified patient database 140 or from the ad hoc data sets (either the ad hoc de-identified data set 142 or the ad hoc PHI data set 144). As noted above, all patient medical data records are stored in encrypted form. Prior to any decoding process, the secure database driver accesses the license server, in step 7, to check the license and thereby assure that any access to data is authorized by the specific license approved by the hospital. If data access has been authorized, the license server sends a private key in step 8. The secure database driver utilizes the private key to decrypt the data and thereby provide decoded data in step 9.

In a typical implementation, the researcher operations and the operations of the secure database driver are performed by the client computer 106 (see FIG. 1). Hospital operations may typically be performed by the server computer 120. The license server may be part of the server computer 120 or may be implemented by a separate computer for enhanced security. Those skilled in the art will appreciate that distributed computing systems allow various implementations of the process illustrated in FIG. 10. For example, the secure database driver may be part of the client computer 106 or implemented by a separate computer. Accordingly, the system 100 is not limited by a specific computer architecture or implementation of the various processes illustrated in FIG. 10 by any specific computer within the system 100.

The researcher may utilize data in accordance with the terms and conditions of the license agreement. In certain circumstances, the license agreement may authorize viewing only of the data and may not permit copying or printing of the patient medical record data. In yet other conditions, the license server may provide access to the data for only a limited time (e.g. 30 days).

The secure database driver can be used to assure proper implementation of the terms and conditions of the license agreement. In one embodiment, the secure database driver may be an open database connectivity (ODBC) driver. ODBC is known in the art as an interface that provides a common language for certain applications to gain access to a database on a network. If the secure database driver is an ODBC driver, it may contain printer drivers, and drivers to permit data file copying. By enabling or disabling such drivers, the license server can provide the required degree of security with patient data. Those skilled in the art will also appreciate that various database programs, such as Access or dBASE, and database management systems, such as a structured query language (SQL) server each have a different driver. The actual implementation of the secure database driver in FIG. 10 may depend on the specific implementation of the de-identified patient database 140 and the ad hoc data sets (i.e. the ad hoc de-identified data set 142 and the ad hoc PHI data set 144). The ODBC drivers are system-level drivers that can prevent printing and copying and to enable or disable certain functions. The operation of such drivers is known in the art and need not be described in greater detail herein.

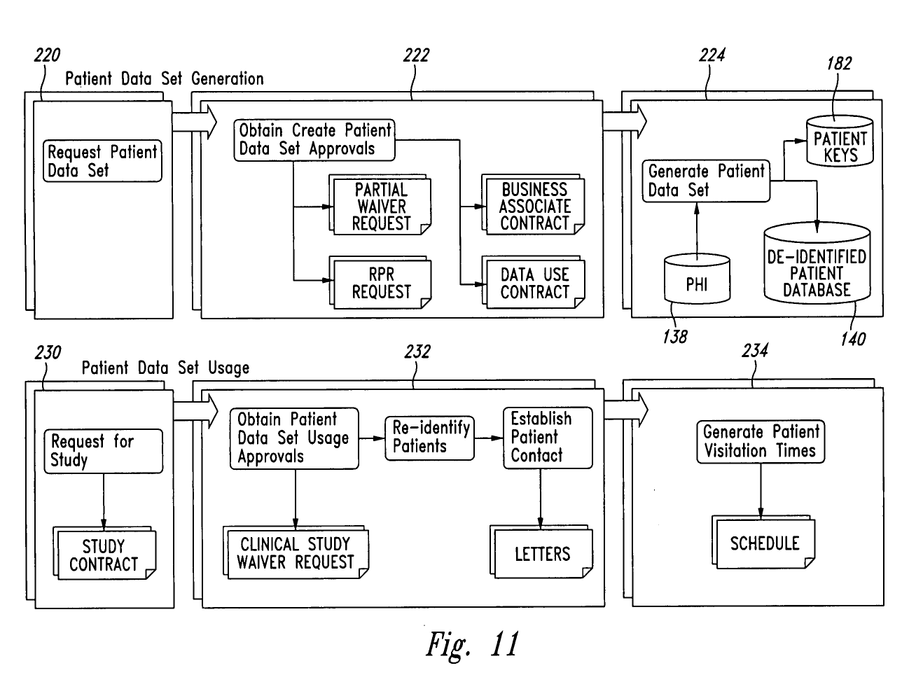

FIG. 11 provides an overview of work flow product in the generation of patient data sets and in the usage of patient data sets. The generation of patient data sets begins at 220 with a request for a patient data set. When patients are seen at a hospital, clinic, or other institution, authorization is obtained to collect medical data necessary for patient treatment. The access and use of such medical data is strictly controlled. Approval may be granted by the IRB in response to a partial waiver request or a request preparatory to research (RPR). In certain cases, the hospital or other institution may have business associate contracts or data use agreements with other institutions that allow direct use of the PHI 138. These affiliated organizations operate under the regulatory control of HIPAA or other forms of regulation. For example, a radiology department or laboratory services department may be located within a medical institution, but is formed as a separate corporate entity. A business associate contract authorizes the separate entity to use the PHI 138.

Following the necessary approval process, the de-identified patient database 140 is created at step 224, where the PHI 138 is processed by the data extraction and de-identification agent 180 (see FIG. 3) to create the de-identified patient database 140 in the manner described above.

Patient data set usage is also illustrated in FIG. 11 where a request for study is generated at 230. The request for study typically includes a study contract indicating the type of data requested and the potential use of the data obtained for the study. The process of IRB approval of research requests have previously been discussed with respect to FIG. 10. In step 232, it is necessary to obtain patient data set usage approvals. The researcher may submit the patient data set usage approval in the form of a clinical study waiver request, which is reviewed by the IRB. It should be noted that the patient data set generation (i.e., the creation of the ad hoc data set 142 of FIG. 3) requires one level of approval by the IRB. The patient data set usage, which requires re-identification of patients, requires a separate approval by the IRB.

As described above, the services hub 200 (see FIG. 3) conveniently provides automatic initiation of many of the tasks required for patient data set generation and usage. For example, automatic initiation of tasks, such as usage approval, may be initiated by the services hub 200. The services hub 200 may automatically prepare a clinical study waiver request for approval by the IRB. In an exemplary embodiment, the services hub 200 may utilize standard forms, such as those required by HIPAA or by other government agencies (e.g., NIH forms) or load hospital, specific forms and documents as part of the approval process. Automatic approval, authorization and authentication check is also provided by the services hub 200. That is, the services hub 200 checks to see if requests (e.g., the clinical study waiver request) have been previously submitted and approved.

If it is necessary to re-identify patients, the de-identified ad hoc data sets are processed by the services hub 200 and the re-identification agent 192 (see FIG. 3) to reassociate patient identification data with the associated patient medical record data.

Also illustrated at step 232 is a process to establish patient contact. Patient contact may be established by the primary care physician via letters or other forms of correspondence to determine if the patient is interested in participating in a research study or clinical trial. The system 100 can automatically generate the necessary forms to accompany a letter by the primary care physician. In an alternative embodiment, the system 100 may automatically generate all correspondence to the patient to determine the patient interest in participation if a patient ops out of a study, the patient is placed on a list in the system 100 to prevent subsequent access to PHI data. However, in one embodiment, a patient opt-out does not prohibit use of previously obtained patient medical data.

At step 234, the system 100 may generate patient visitation times. It should be noted that any patient medical data collected from this point on falls within HIPAA and is collected with patient approval. Access to the de-identified patient data base 140 is typically no longer required. However, access to the de-identified patient database 140 or to the ad hoc data sets 142-144 are still controlled by the services hub 200. Thus, the system 100 provides work flow control over the process of data set generation and data set use and provides the appropriate regulatory compliance for both processes.

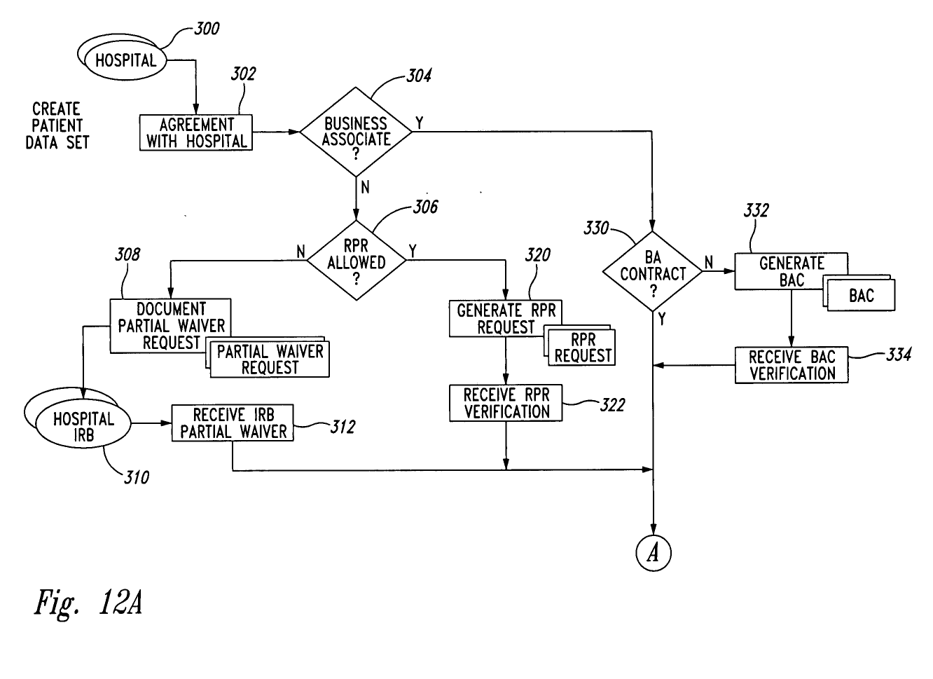

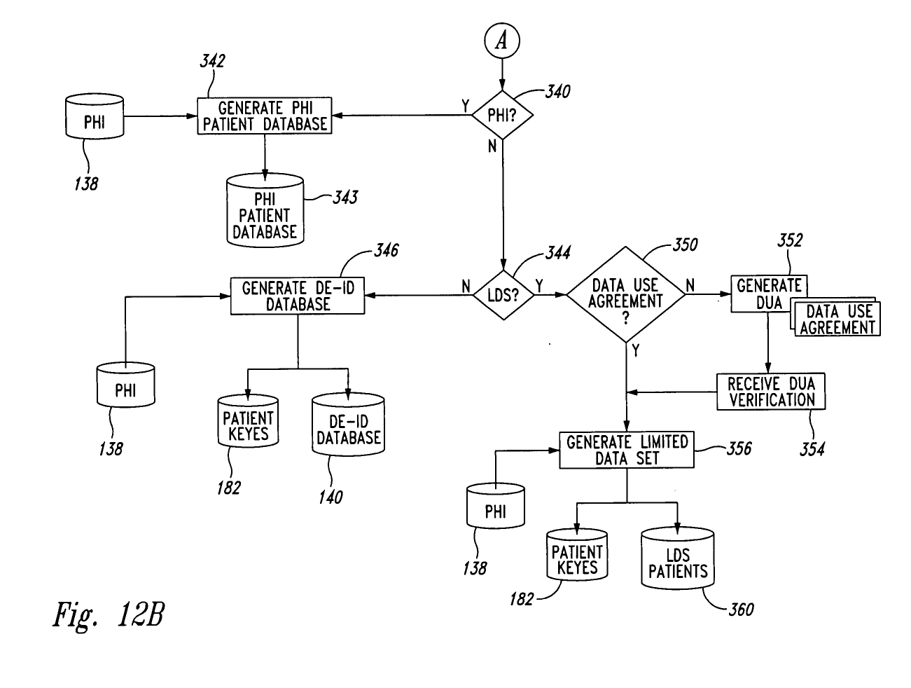

FIGS. 12A-12B form a flow chart illustrating the operation of the system 100 for data set generation. The process begins at 300 with a hospital operating to create a patient data set. As previously noted, affiliated organizations or associates may have agreements with the hospital as noted in 302. In decision 304, the system 100 determines whether there is a business associate relationship if no business associate relationship exists, the result of decision 304 is NO and, in decision 306, the system 100 checks to determine whether the particular medical institution permits a request preparatory to research (RPR) approval process or requires a partial waiver approval. If an RPR approval process is not allowed, the result of decision 306 is NO and, at 308, the researcher or requesting entity submits a partial waiver request. As previously noted, the partial waiver request includes details of the type of patient data required, purpose or use of the data and the like. The partial waiver request may also include documentation, such as governmental support (e.g. a research grant). The hospital IRB reviews the partial waiver request at 310 and at 312 provides the IRB partial waiver.

Returning to decision 306, if the RPR process is allowed by the hospital IRB, the result of decision 306 is YES. In that event in step 320 the system 100 generates an RPR request. Following the generation of the RPR request, the system 100 receives RPR verification.

As previously discussed, the hospital may have affiliated or allied business associates. If the entity requesting access to patient data is a business associate, the result of decision 304 is YES. In decision 330, the system determines whether a business associate contract exists. If a business associate contract does not exist, the result of decision 330 is NO and in step 332, the system 100 generates a business associate contract (BAC). Following the necessary approval process, the system 100 receives BAC verification in step 334. If a BAC already exists, the result of decision 330 is YES.

Upon completion of the necessary verifications of authorization (i.e. the receipt of IRB partial waiver in step 312, the receipt of RPR verification in step 322, the verification of existence of a BAC by decision 330 or the receipt of a BAC verification in step 334), the system 100 moves to decision 340, shown in FIG. 12B, to determine whether the request requires access to the PHI 138 (see FIG. 2). In some settings, such as where a business associate is working in conjunction with the medical institution, the business associate may have access to the PHI 138. In an alternative setting, it may be desirable to permit the business associate to have access to portions of the PHI 138. If PHI access is required or permitted, the result of decision 340 is YES and in step 342, the system 100 accesses the PHI 138 to generate a PHI database 343. The PGI patient database 343 may comprise all or part of the PHI 138. It can be appreciated that the PHI patient database 343 falls within the regulatory requirements HIPAA. Accordingly, the system 100 may be used to control access to the PHI patient database 343 and the use of data therein.

If PHI data access is not required, the result of decision 340 is NO. In that event, the system moves to decision 344 to determine whether the request involves a limited data set. If a limited data set is not required, the result of decision 344 is NO. In that event, the system 100 may access the PHI and utilize the data extraction and de-identification agent 180 (see FIG. 3) to generate the de-identified patient database 140 in step 346. As part of the process for generating the de-identified patient database 140, the data extraction and de-identification agent 180 also generates the key file 182.

If limited data set generation is required, the result of decision 344 is YES. In that event, the system 100 moves to decision 350 to determine whether a data use agreement has been previously generated. If a data use agreement has not been generated, the result of decision 350 is NO and, in step 352, the system generates a data use agreement. The system 100 receives data use agreement verification in step 354.

If a data use agreement has been previously approved, the result of decision 350 is YES. In that event, or upon receipt of data use agreement verification in step 354, the system 100 generates a limited data set in step 356. A limited data set 360 may include partial patient identification, such as dates of service, location of the delivery of service, and the like. The limited data set generally does not include specific patient identification data. Nonetheless, the limited data set falls within the regulatory guidelines of HIPAA because it includes some patient identification data.

FIGS. 12A-12B have been provided to illustrate one possible implementation of the system 100 for data set generation. Those skilled in the art will recognize that other techniques may be used to generate the necessary data sets. For example, FIGS. 12A-12B illustrate the direct generation of the ad hoc PHI data set 144 directly from the PHI 138. Such operation may be implemented when used in a single hospital environment where access to de-identified patient data may not be necessary. Alternatively, the system 100 may implement the intermediate process of generating the de-identified patient database 140, using a process such as that illustrated in FIG. 3. In the various implementations, the regulatory restrictions of HIPAA and/or other data use restrictions are implemented by the system 100 to prevent unauthorized use of patient medical record data. In the flow chart illustrated in FIGS. 12A-12B, the system 100 also includes a number of checks and balances to assure that proper agreements and verifications are in place prior to any access of confidential patient information.

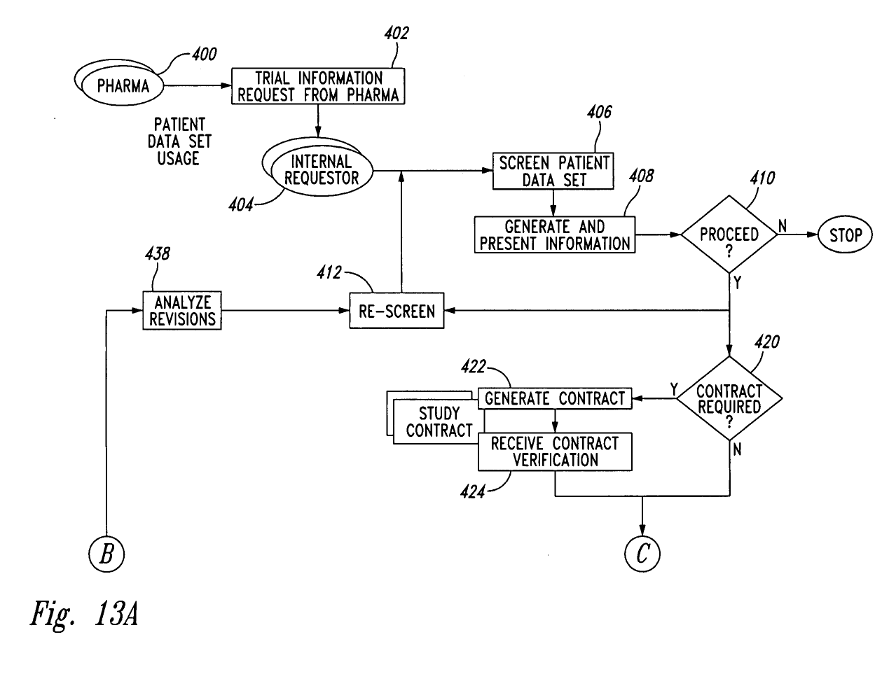

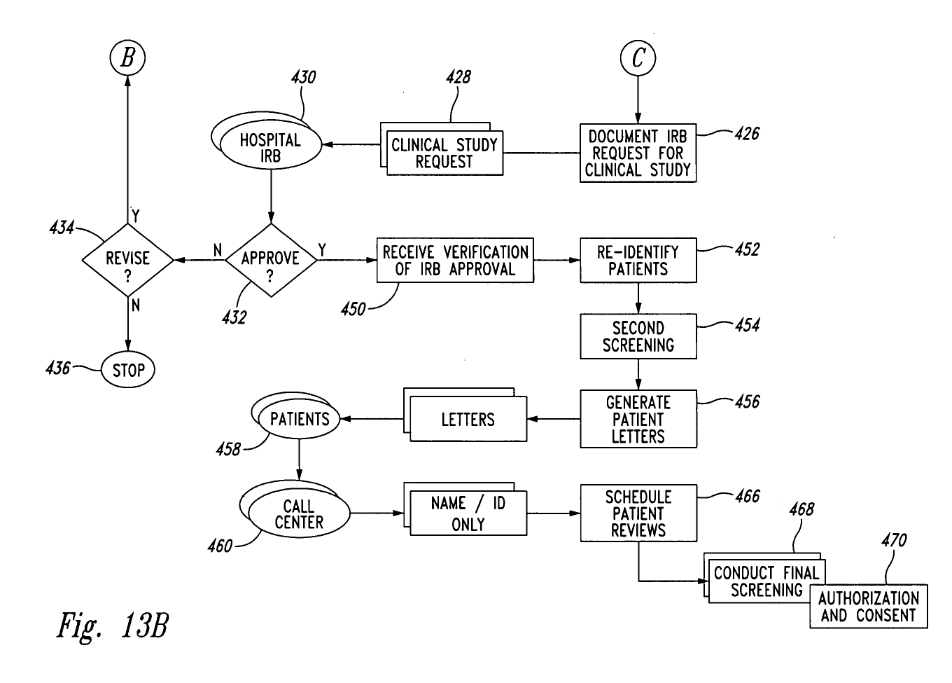

FIGS. 13A-13B are a flow chart illustrating one implementation of the system 100 for patient recruitment and data usage. At a start 400, a research entity, such as a pharmaceutical company, wishes access patient data records for clinical or research purposes. At step 402, trial information or other research details are provided in a request from the researcher. If the request comes from an entity outside the institution, an internal requester, such as a staff doctor or medical researcher is also included in the request in step 404.

In step 406, the system 100 screens patient data, such as data from the de-identified patient database 140 to select possible candidates for the research effort. In step 408, the system 100 generates and presents information in response to, by way of example, the patient queries implemented by patient query agent 184 (see FIG. 3).

In decision 410, the researchers may determine whether or not to proceed with the research process. If no suitable candidates or if an insufficient number of suitable candidates were identified, the result may be no and the research effort stops. If the process proceeds, the result of decision 410 is YES. It may be necessary to rescreen patient data in step 412 to expand or limit the scope of the patient queries. If rescreening is required, steps 406-410 may be repeated one or more times.

If further rescreening is not required, the system 100 moves to decision 420 to determine whether a contract is required for further use of the patient data. For example, a business associate does not require a contract for access to the PHI 138. If a contract is required, the result of decision 420 is YES and at 422, the system 100 generates a study contract. At step 424, the system receives contract verification. If no contract is required, the result of decision 420 is NO. In that event, or upon receipt of contract verification in step 424, the system 100 generates the necessary documents for an IRB request for clinical study in step 426, shown in FIG. 13B. As previously noted, the system 100 may automatically generate much of the data required for the review process. For example, documentation listing patient types, use of data, and the like may be automatically generated by the system 100 in step 428. In addition, the system 100 may provide copies of additional support documentation, such as government support, which may be used to further the review process. The hospital review is performed at step 430 and approval is granted or denied in decision 432. If approval is not received, the result of decision 432 is NO and the process moves to decision 434 to determine whether revisions to the procedure may gain the necessary approval. If no revisions are possible, the result of decision 434 is NO and the process stops at 436 with access to patient medical records being denied. If revisions are possible, the result of decision 434 is YES and the system 100 proceeds to step 438, shown in FIG. 13A, where revisions can be analyzed. The result of revision analysis may require rescreening of patient data in step 412 and the subsequent repeat of steps 406-410.

If study approval has been received by the hospital IRB, the result of decision 432 is YES and, in step 450, the system 100 receives verification of IRB approval. As previously noted, approval of a study by hospital IRB results in the generation of a license that is stored in the license server (see FIG. 10). The license server assures that access to patient data is in strict accordance with the terms and conditions of the license. As noted above, these may involve restrictions on the type of data supplied to the researcher, use of the data (e.g. copying or printing data) and time constraints involving the access to patient data.

In a pharmaceutical clinical trial, such illustrated in FIGS. 13A-13B, it is necessary to re-identify patients that have been selected in the screening process from the de-identified patient database 140. In step 452, the services hub 200 (see FIG. 3) and re-identification agent 190 process the ad hoc de-identified data set 142 to re-identify patients.

In step 454, a second screening may be performed on the now re-identified patients to assure appropriate matches with the selection criteria. In step 456, the system 100 generates patient letters. As previously noted, the system 100 may also generate all necessary approval forms and complete the forms for patient signature. Letters are sent to the patients in step 458, and patients who wish to participate in the study may contact a call center at step 460. To further enhance security with respect to the PHI 138, a call center typically does not handle any confidential patient information. Rather, the patient name or identification number (unrelated to the key stored in the key file 182 (FIG. 3) may be provided to the call center to identify the patient and the particular study for which the patient has been contacted.

In step 466, the system 100 may generate a schedule of patient interviews. As part of the patient interview, it may be necessary to conduct a final screening at step 468 and obtain proper authorization from the patient at step 470. Thus, the system 100 provides additional checks and balances so as to limit access to confidential patient data and to assure that all regulatory processes have been implemented.

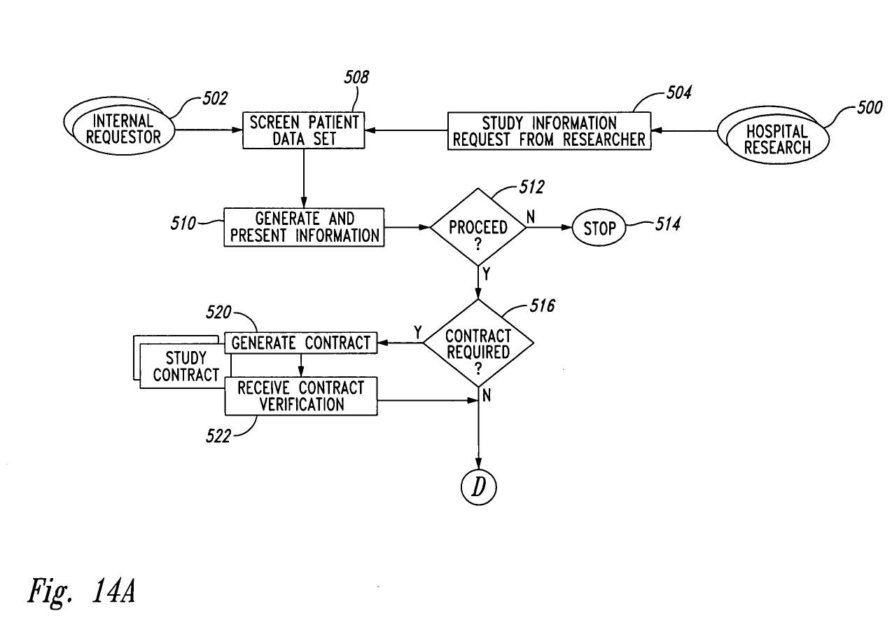

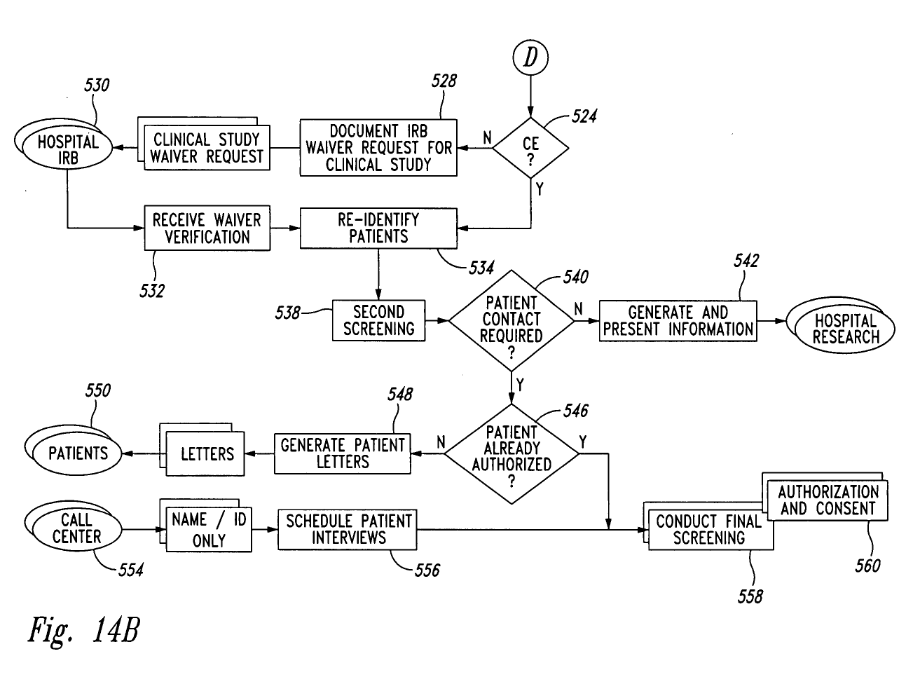

FIGS. 13A-13B illustrated the operation of the system 100 to control access to and use of the PHI for patient recruitment. FIGS. 14A-14B form a flow chart that illustrates a similar process used by the system 100 to control access to and use of the PHI for patient research purposes. The primary difference in the flow charts of FIGS. 13 and 14 is that research studies may not require actual patient participation. Requests for access to patient medical information may come from a hospital research request 500 or from an internal requester (e.g., a researcher within the medical institution). Following internal guidelines, the internal requester 502 may directly screen the patient data set in step 508. If the request to screen the patient data set comes via the hospital research 500, a request from the researcher includes information described above regarding the need for patient data and the proposed use thereof. In step 508, the system 100 screens the patient data set. As described above, patient queries may be used to select potential patients from the de-identified patient database 140. In step 510, the system generates and presents information, which may be in the form of the ad hoc data set 142 (see FIG. 3). In decision 512, the researcher determines whether there are sufficient number of patients to proceed. If there is inadequate patient selection, the result of decision 512 is NO and the process stops at 514. If there are sufficient number of patients selected as a result of patient queries, the result of decision 512 is YES.

If a sufficient number of patients are selected, the process moves to decision 516 to determine whether a contract is required. As previously noted, contracts are not required from business associates. If a contract is required, the results of decision 516 is YES and, at step 520 the services hub 200 (see FIG. 3) generates a contract. Aspects of the contract have already been discussed and need not be repeated. At step 522, the system 100 verifies receipt of the contract.

Following verification of contract receipt in step 522, or if a contract is not required (i.e., the result of decision 516 is NO), the system 100 moves to decision 524, shown in FIG. 14B, to determine whether the entity requesting patient medical information and patient identification information is covered entity. Those familiar with medical research procedures will recognize that multiple hospitals often participate in a clinical study. The hospital that is the site of the clinical study is referred to in FIGS. 14A-14B as the “covered entity.” If the request for patient information is made to a medical institution that is not the site of the clinical study (i.e., not the covered entity) it may be necessary to obtain the approval of that hospital's internal revue board before that hospital will release information regarding its patients. With respect to decision 524, if the patient medical information and patient identification information is requested from a medical institution other than the covered entity, the result of decision 524 is NO and the process moves to step 528 to document the IRB waiver request for the clinical study. As previously discussed, any requests for clinical study waivers must be approved by an individual or committee shown in FIG. 14B as the hospital IRB 530. At step 532, the system verifies receipt of the waiver and, in step 534 re-identifies patients in the matter described above. Alternatively, if the request for information is made from the medical institution conducting the study (i.e., the covered entity), it is presumed that the approval for use of patient medical data and patient identification data has already been granted. In that case, the result of decision 524 is YES and the system 100 moves directly to step 534 to re-identify patients selected as a result of previous queries to the de-identified patient database 140.

In some studies, a second screening may be required after re-identification of the patients. If so, the system 100 permits a second screening at step 538. This may be in the form of additional patient queries, which may be implemented in the matter described above. Following a second screening, it can be determined if patient contact is required in decision 540. If no patient contact is required, the result of decision 540 is NO and the system 100 generates and presents the requested PHI from the ad hoc PHI data set 144 (see FIG. 3) in step 542.

If patient contact is required, the result of decision 540 is YES and, in decision 546, the system 100 determines whether the patient has already authorized access to PHI data. If access has not been authorized, the result of decision 546 is NO and, in step 548, the services hub 200 generates the necessary patient letters as previously noted, the system 100 may also generate all necessary approval forms and complete the forms for patient signature. The authorization letters are sent to the patients at 550. Patients wishing to participate in the research may contact the call center at step 554. Alternatively, patients may contact the call center at 554 to opt out of the study. Patients who opt out of a study are processed in a manner described above. In step 556, the system 100 schedules patient interviews. Following patient interviews, or if patient participation has already been authorized (i.e., the result of decision 546 is YES), the final patient screening is conducted at step 558 and the appropriate authorization and consent is obtained from the patient at step 560.

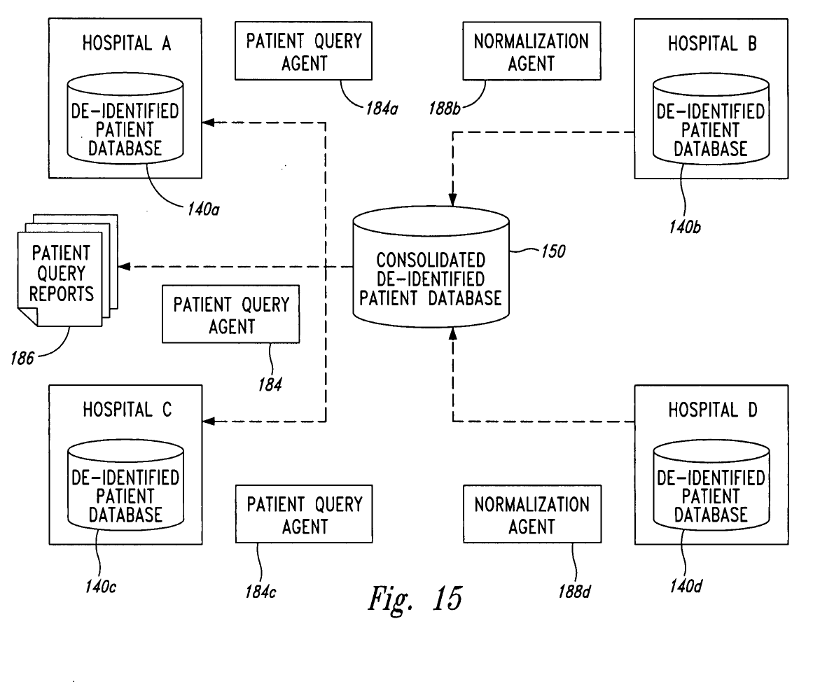

The system 100 has been previously described with a simple implementation in a single hospital environment. However, the system 100 may be readily implemented using multiple hospitals. An example implementation of the system 100 for multiple hospitals is illustrated in FIG. 15, where Hospitals A-D each has a de-identified database 140, each hospital may provide its de-identified patient database to a consolidated de-identified patient database 150. The patient agent query 184 may operate in the manner previously described with respect to a single de-identified patient database 140 in order to generate patient query reports 186. In this manner, multiple hospitals may advantageously combine de-identified patient data to include a greater number of patients for screening purposes. Because different hospitals may store PHI in different formats, a normalization agent can be used to modify data to provide uniformity in the consolidated de-identified patient database 150. In the example of FIG. 15, the normalization agent 188B converts data from the de-identified patient database 140B to alter any format or data structure differences between the de-identified patient database 140B and the consolidated de-identified patient database 150. As one example, one hospital may list male and female patients by a “M” and “F,” respectively while another hospital may list male and female patients using a “1” and a “2” respectively. The normalization agent can be readily configured to review the de-identified patient database in a hospital to make the necessary changes to allow uniformity in the data stored in the consolidated de-identified patient database 150. The normalization agent 188D performs similar operation on the de-identified patient database 140D.

Those skilled in the art will recognize that a variety of implementations may be used in the system illustrated in FIG. 15. For example, FIG. 15 illustrates a patient query agent 184A and a patient query agent 184C. As previously discussed, agents, such as the patient query agent 184, are typically implemented as a set of computer instructions stored in a memory and executed by a processor. In the example illustrated in FIG. 15, the patient query agent 184A may be transmitted from a central location to Hospital A to analyze the de-identified patient database 140 in Hospital A. This process avoids the need for delivery of all the de-identified patient data record to the consolidated de-identified patient database 150. In this implementation, the patient query agent 184 extracts the patient data records from the de-identified patient database 140A and delivers the filtered results in the form of the patient query reports 186. The patient query agent 184A may also deliver data to an ad hoc de-identified set 142 (see FIG. 3) using data derived from the de-identified patient database 140A.

Similarly, the patient query agent 184C may be delivered to Hospital C and directly query the de-identified patient database 140C to match patient data records with the patient selection criteria contained within the queries created by the researcher. The delivery of patient query agents, such as the patient query agent 184A and the patient query agent 184C, may provide greater security to hospitals that do not wish to share all data. In the example illustrated in FIG. 15, Hospital B may be willing to share all de-identified patient data from the de-identified patient database 140B to the consolidated de-identified patient database 150. At the same time, additional restrictions imposed by Hospital A prevent such complete sharing. The delivery of the patient query agent 184A to Hospital A allows the direct query of the de-identified patient database 140A without the delivery of all records to the consolidated patient database 150.

In another implementation of the system 100, the patient query agent, such as the patient query agent 184C, may be delivered to the hospital and provide only summary information. In this example, Hospital C may have further restrictions to prevent the delivery of any de-identified patient data except summary data. For example, summary data may include the number of males and females between the ages of 40-65 who have diabetes and are on the medication Metformin. The summary data in this example does not provide any information about a specific patient (even in un-identified form). In accordance with the restrictions imposed by Hospital C, the patient query agent 184C is delivered to Hospital C and queries the de-identified patient database 140C. However, the patient query agent 184C will only deliver the summary data in accordance with the restrictions imposed by Hospital C. Thus, even in a multi-hospital environment, each hospital may be assured that its own regulatory processes are met and that only data is delivered in strict accordance with its own policies as well as meeting all government regulatory requirements.

From the foregoing it will be appreciated that, although specific embodiments of the invention have been described herein for purposes of illustration, various modifications may be made without deviating from the spirit and scope of the invention. For example, the present description provides numerous examples using a hospital setting. However, those skilled in the art will appreciate that any medical institution, such as a hospital, clinic, research facility, university, pharmaceutical company, governmental organization or the like may benefit from the system and control of the PHI for the respective medical institution. Accordingly, the present invention is not limited to a hospital setting.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

1. A system to control access to a protected health information (PHI) storage structure that stores patient identification data and associated patient medical data comprising:
a de-identified data storage structure to store patient medical data in a manner that is disassociated from the patient identification data;
a key file containing data interrelating the disassociated patient identification data and the patient medical data;
an authorization controller to process data access requests, the authorization controller receiving an access request, comparing the received access request with a predetermined data access authorization and, if the received access request complies with the predetermined data access authorization, permitting access to patient medical data.

2. The system of claim 1, further comprising a de-identification agent to process the patient identification data and associated patient medical data to thereby disassociate the patient medical data and patient identification data to thereby generate the disassociated patient medical data.

3. The system of claim 2 wherein the de-identification agent generates a key to relate the patient identification data and associated patient medical data to thereby permit subsequent reassociation of the disassociated patient medical data with the patient identification data, the key being stored in the key file.

4. The system of claim 3 wherein the de-identification agent generates a random key, the random key being stored in the key file.

5. The system of claim 1 wherein the received access request requires association of patient identification data and patient medical data, the system further comprising a re-identification agent to process data in the key file and thereby re-associate the patient medical data and patient identification data to thereby generate re-identified patient medical data.

6. The system of claim 5 wherein the received access request for re-identified patient medical data is processed by the authorization processor, the re-identification agent processing data in the key file to re-associate the patient medical data and patient identification data only if the predetermined data access authorization permits re-association of the patient medical data and patient identification data.

7. The system of claim 1, further comprising a patient query agent having user-selectable patient selection criteria, the patient query agent being configured to query patient medical data to select patients having characteristics conforming to the user-selectable patient selection criteria.

8. The system of claim 7 wherein the patient query agent is configured to query disassociated patient medical data in the de-identified data storage structure to select patients having characteristics conforming to the user-selectable patient selection criteria.

9. The system of claim 8 wherein patient medical data selected from patients having characteristics conforming to the user-selectable patient selection criteria are placed in a de-identified query data storage structure.

10. The system of claim 7 wherein the patient query agent operatively communicates with the authorization processor and queries patient medical data only if the received access request complies with the predetermined data access authorization.

11. The system of claim 7 wherein patient medical data selected from patients having characteristics conforming to the user-selectable patient selection criteria are placed in a query data storage structure.

12. The system of claim 1 wherein the received access request indicates a type of data required and a purpose associated with the use of data, the authorization processor accepting authorization input based on a review board authorization to permit access to de-identified patient medical data or patient medical data associated with patient identification data.

13. The system of claim 1, further comprising a logging system to log access to patient medical data.

14. The system of claim 1 wherein the authorization processor controls subsequent use of patient medical data to which access is permitted.

15. The system of claim 14 wherein the authorization processor permits subsequent use of patient medical data to which access is permitted only for a predetermined period of time.

16. The system of claim 14 wherein the authorization processor prohibits printing of patient medical data to which access is permitted.

17. The system of claim 14 wherein the authorization processor prohibits copying of patient medical data to which access is permitted.

18. A system to control access to a protected health information (PHI) storage structure in each of a plurality of medical institutions that stores patient identification data and associated patient medical data of the respective medical institutions, the system comprising:
a de-identified data storage structure to store patient medical data in a manner that is disassociated from the patient identification data;
a key file containing data interrelating the disassociated patient identification data and the patient medical data;
an authorization controller to process data access requests, the authorization controller receiving an access request, comparing the received access request with a predetermined data access authorization and, if the received access request complies with the predetermined data access authorization, permitting access to patient medical data.

19. The system of claim 18 wherein the de-identified data storage structure is configured to store patient medical data from more than one of the plurality of medical institutions.

20. The system of claim 19 wherein the de-identified data storage structure is a single data storage structure configured to store patient medical data from the plurality of medical institutions.

21. The system of claim 18, further comprising a de-identification agent to process the patient identification data and associated patient medical data to thereby disassociate the patient medical data and patient identification data to thereby generate the disassociated patient medical data.

22. The system of claim 21 wherein a single de-identification agent processes the patient identification data and associated patient medical data in the PHI storage structure in more than one of the plurality of medical institutions.

23. The system of claim 21 wherein a single de-identification agent is delivered to a selected on the plurality of medical institutions to process the patient identification data and associated patient medical data in the PHI storage structure of the selected one of the plurality of medical institutions.

24. The system of claim 23 wherein the de-identification agent delivered to the selected on the plurality of medical institutions processes the patient identification data and associated patient medical data in the PHI storage structure of the selected one of the plurality of medical institutions and provides only summary patient medical data to the de-identified data storage structure.

25. The system of claim 21 wherein the de-identification agent generates a key to relate the patient identification data and associated patient medical data to thereby permit subsequent re associate the disassociated patient medical data with the patient identification data, the key being stored in the key file.

26. The system of claim 18 wherein the received access request requires association of patient identification data and patient medical data, the system further comprising a re-identification agent to process data in the key file and thereby re-associate the patient medical data and patient identification data to thereby generate re-identified patient medical data.

27. The system of claim 26 wherein the received access request for re-identified patient medical data is processed by the authorization processor, the re-identification agent processing data in the key file to re-associate the patient medical data and patient identification data only if the predetermined data access authorization permits re-association of the patient medical data and patient identification data.

28. The system of claim 18, further comprising a patient query having user-selectable patient selection criteria, the patient query agent being configured to query patient medical data to select patients having characteristics conforming to the user-selectable patient selection criteria.

29. The system of claim 28 wherein the patient query agent is configured to query disassociated patient medical data in the de-identified data storage structure to select patients having characteristics conforming to the user-selectable patient selection criteria.

30. The system of claim 28 wherein the de-identified data storage structure is configured to store patient medical data from more than one of the plurality of medical institutions and the patient query agent is configured to query disassociated patient medical data in the de-identified data storage structure to select patients having characteristics conforming to the user-selectable patient selection criteria.

31. The system of claim 28 wherein the patient query agent operatively communicates with the authorization processor and queries patient medical data only if the received access request complies with the predetermined data access authorization.

32. The system of claim 18 wherein the received access request indicates a type of data required and a purpose associated with the use of data, the authorization processor accepting authorization input based on a review board authorization to permit access to de-identified patient medical data or patient medical data associated with patient identification data.

33. The system of claim 18, further comprising a logging system to log access to patient medical data.

34. The system of claim 18 wherein the authorization processor controls subsequent use of patient medical data to which access is permitted.

35. The system of claim 34 wherein the authorization processor permits subsequent use of patient medical data to which access is permitted only for a predetermined period of time.

36. The system of claim 34 wherein the authorization processor prohibits printing of patient medical data to which access is permitted.

37. The system of claim 34 wherein the authorization processor prohibits copying of patient medical data to which access is permitted.

38. A method for controlling access to patient medical data stored in a protected health information (PHI) storage structure to store patient identification data and associated patient medical data, the method comprising:
storing patient medical data in a de-identified data structure in a manner that disassociates patient medical data from the patient identification data;
storing data interrelating the disassociated patient identification data and the patient medical data;
receiving an access request to access patient medical data;
comparing the received access request with a predetermined data access authorization; and
permitting access to patient medical data if the received access request complies with the predetermined data access authorization.

39. The method of claim 38, further comprising processing the patient identification data and associated patient medical data to thereby disassociate the patient medical data and patient identification data to thereby generate the disassociated patient medical data.

40. The method of claim 39, further comprising generating a key to relate the patient identification data and associated patient medical data to thereby permit subsequent re associate the disassociated patient medical data with the patient identification data wherein storing data interrelating the disassociated patient identification data and the patient medical data comprises storing the key.

41. The method of claim 38 wherein the received access request requires association of patient identification data and patient medical data, the method further comprising processing the stored data interrelating the disassociated patient identification data and the patient medical data to thereby re-associate the patient medical data and patient identification data to thereby generate re-identified patient medical data.

42. The method of claim 38, further comprising receiving a patient query having user-selectable patient selection criteria and querying patient medical data to select patients having characteristics conforming to the user-selectable patient selection criteria.

43. The method of claim 42 wherein the patient querying comprises querying the disassociated patient medical data in the de-identified data storage structure to select patients having characteristics conforming to the user-selectable patient selection criteria.

44. The method of claim 38 wherein the received access request indicates a type of data required and a purpose associated with the use of data, the method further comprising accepting authorization input based on a review board authorization to permit access to de-identified patient medical data or patient medical data associated with patient identification data.

45. The method of claim 38, further comprising logging access to patient medical data.

46. The method of claim 38, further comprising controlling subsequent use of patient medical data to which access is permitted.

47. The method of claim 46 wherein controlling subsequent use comprises permitting subsequent use of patient medical data to which access is permitted only for a predetermined period of time.

48. The method of claim 46 wherein controlling subsequent use comprises prohibiting printing of patient medical data to which access is permitted.

49. The method of claim 46 wherein controlling subsequent use comprises prohibiting copying of patient medical data to which access is permitted.

50. A method for controlling access to patient medical data stored in a protected health information (PHI) storage structure in each of a plurality of medical institutions to store patient identification data and associated patient medical data, the method comprising:
storing patient medical data in a de-identified data structure in a manner that disassociates patient medical data from the patient identification data;
storing data interrelating the disassociated patient identification data and the patient medical data;
receiving an access request to access patient medical data;
comparing the received access request with a predetermined data access authorization; and
permitting access to patient medical data if the received access request complies with the predetermined data access authorization.

51. The method of claim 50 wherein storing patient medical data in the de-identified data storage structure comprises storing patient medical data from more than one of the plurality of medical institutions.

52. The method of claim 50, further comprising processing the patient identification data and associated patient medical data to thereby disassociate the patient medical data and patient identification data to thereby generate the disassociated patient medical data.

53. The method of claim 52 wherein processing the patient identification data and associated patient medical data comprises processing the patient identification data and associated patient medical data in the PHI storage structure of a selected one of the plurality of medical institutions and providing only summary patient medical data to the de-identified data storage structure.

54. The method of claim 52, further comprising generating a key to relate the patient identification data and associated patient medical data to thereby permit subsequent re associate the disassociated patient medical data with the patient identification data wherein storing data interrelating the disassociated patient identification data and the patient medical data comprises storing the key.

55. The method of claim 50 wherein the received access request requires association of patient identification data and patient medical data, the method further comprising processing the stored data interrelating the disassociated patient identification data and the patient medical data to thereby re-associate the patient medical data and patient identification data to thereby generate re-identified patient medical data.

56. The method of claim 50, further comprising receiving a patient query having user-selectable patient selection criteria and querying patient medical data to select patients having characteristics conforming to the user-selectable patient selection criteria.

57. The method of claim 50 wherein the patient querying comprises querying the disassociated patient medical data in the de-identified data storage structure to select patients having characteristics conforming to the user-selectable patient selection criteria.

58. The method of claim 50 wherein the de-identified data storage structure is configured to store patient medical data from more than one of the plurality of medical institutions and the patient query agent is configured to query disassociated patient medical data in the de-identified data storage structure to select patients having characteristics conforming to the user-selectable patient selection criteria.

59. The method of claim 50 wherein the received access request indicates a type of data required and a purpose associated with the use of data, the method further comprising accepting authorization input based on a review board authorization to permit access to de-identified patient medical data or patient medical data associated with patient identification data.

60. The method of claim 50, further comprising logging access to patient medical data.

61. The method of claim 50, further comprising controlling subsequent use of patient medical data to which access is permitted.

62. A computer-readable media for controlling access to patient medical data stored in a protected health information (PHI) storage structure configured to store patient identification data and associated patient medical data by causing a computer to:
store patient medical data in a de-identified data structure in a manner that disassociates patient medical data from the patient identification data;
store data interrelating the disassociated patient identification data and the patient medical data;
receive an access request to access patient medical data;
compare the received access request with a predetermined data access authorization; and
permit access to patient medical data if the received access request complies with the predetermined data access authorization.

63. The computer-readable media of claim 62, further comprising instructions to cause the computer to process the patient identification data and associated patient medical data to thereby disassociate the patient medical data and patient identification data to thereby generate the disassociated patient medical data.

64. The computer-readable media of claim 63, further comprising instructions to cause the computer to generate a key to relate the patient identification data and associated patient medical data to thereby permit subsequent re associate the disassociated patient medical data with the patient identification data wherein storing data interrelating the disassociated patient identification data and the patient medical data comprises storing the key.

65. The computer-readable media of claim 62 wherein the received access request requires association of patient identification data and patient medical data, the computer-readable media further comprising instructions to cause the computer to process the stored data interrelating the disassociated patient identification data and the patient medical data to thereby re-associate the patient medical data and patient identification data to thereby generate re-identified patient medical data.

66. The computer-readable media of claim 62, further comprising computer instructions to cause the computer to receive a patient query having user-selectable patient selection criteria and to query patient medical data to select patients having characteristics conforming to the user-selectable patient selection criteria.

67. The computer-readable media of claim 66 wherein the patient querying comprises querying the disassociated patient medical data in the de-identified data storage structure to select patients having characteristics conforming to the user-selectable patient selection criteria.

68. The computer-readable media of claim 62 wherein the received access request indicates a type of data required and a purpose associated with the use of data, the computer-readable media further comprising computer instructions to cause the computer to accept authorization input based on a review board authorization to permit access to de-identified patient medical data or patient medical data associated with patient identification data.

69. The computer-readable media of claim 62, further comprising computer instructions to cause the computer to log access to patient medical data.

70. The method of claim 62, further comprising computer instructions to cause the computer to control subsequent use of patient medical data to which access is permitted.

71. The computer-readable media of claim 70 wherein controlling subsequent use comprises permitting subsequent use of patient medical data to which access is permitted only for a predetermined period of time.

72. The computer-readable media of claim 70 wherein controlling subsequent use comprises prohibiting printing of patient medical data to which access is permitted.

73. The computer-readable media of claim 70 wherein controlling subsequent use comprises prohibiting copying of patient medical data to which access is permitted.

74. The computer-readable media of claim 62 wherein patient medical data is stored in a protected health information (PHI) storage structure in each of a plurality of medical institutions and the computer instructions cause the computer to store patient medical data in the de-identified data storage structure comprises storing patient medical data from more than one of the plurality of medical institutions.

75. The computer-readable media of claim 74, further comprising computer instructions to cause the computer to process the patient identification data and associated patient medical data to thereby disassociate the patient medical data and patient identification data to thereby generate the disassociated patient medical data.

76. The computer-readable media of claim 75 wherein processing the patient identification data and associated patient medical data comprises processing the patient identification data and associated patient medical data in the PHI storage structure of a selected one of the plurality of medical institutions and providing only summary patient medical data to the de-identified data storage structure.

77. The computer-readable media of claim 74 wherein the de-identified data storage structure is configured to store patient medical data from more than one of the plurality of medical institutions, the computer-readable further comprising computer instructions to cause the computer to query disassociated patient medical data in the de-identified data storage structure to select patients having characteristics conforming to the user-selectable patient selection criteria.

78. The computer-readable media of claim 74, further comprising computer instructions to cause the computer to log access to patient medical data.

79. The computer-readable media of claim 74, further comprising computer instructions to cause the computer to control subsequent use of patient medical data to which access is permitted.
